(19) United States
(12) Patent Application Publication
(10) Pub. No.: US 2012/0292824 A1
(43) Pub. Date: Nov. 22, 2012

(54) Fire Resistant Glazings

(75) Inventors: Karikath Sukumar Varma, Southport (GB); John Richard Holland, Lancashire (GB); David William Holden, Greater Manchester (GB); Stephen Ian Bond, Chestire (GB); Allan Stuart Dale, Greater Manchester (GB)

(73) Assignee: PILKINGTON PLC, St. Helens (GB)

(21) Appl. No.: 13/567,935

(22) Filed: Aug. 6, 2012

Related U.S. Application Data
(63) Continuation of application No. 10/489,991, filed on Sep. 17, 2004, now abandoned.

(30) Foreign Application Priority Data
Sep. 20, 2001 (GB) 0122632.3

(51) Int. Cl. B29C 33/38; B29C 39/36

(52) U.S. Cl. 264/337

(57) ABSTRACT

Bilayer materials are produced by drying a solution of an alkali metal silicate upon the surface of a flexible backing material until a flexible silicate film is produced. The film may be separated from the backing material and incorporated into laminated fire resistant glazings. The alkali metal silicate solution preferably comprise a surfactant. The bilayers may be transported or stored before the flexible silicate film is separated and incorporated into a glazing.

### CROSS REFERENCE TO RELATED APPLICATION

This application is a continuation of U.S. Ser. No. 10/489,991 filed Sep. 17, 2004. U.S. Ser. No. 10/489,991 was a US 371 National Stage application of PCT/GB02/04225 filed Sep. 18, 2002. U.S. Ser. No. 10/489,991 was pending as of the filing date of this application and is hereby incorporated by reference as if set forth in its entirety herein.

### BACKGROUND OF THE INVENTION

This invention relates to processes for the production of clear plastic waterglass containing films; to bilayers comprising a combination of these films with a backing material, to processes for the production of such bilayers and to novel compositions useful in the aforesaid processes.

Fire resistant glass laminates incorporating a waterglass based intumescent interlayer are sold by the Pilkington group of companies under the Trade Marks PYROSTOP and PYRODUR. These laminates are produced by pouring a waterglass solution onto the surface of a first glass pane and drying the solution in such a manner that a clear interlayer is formed. A second plane of glass is then placed on top of the interlayer to form a laminate. Laminates containing more than one interlayer and more than two panes of glass are also produced.

The conventional drying processes are carried out over an extended period of time and the production costs are correspondingly high. U.S. Pat. No. 5,565,273 proposes the formation of an interlayer without a drying step utilising a silicate wherein the molar ratio of silicon dioxide to alkali metal oxide is greater than 4:1 and a curing agent. The incorporation of a relatively large quantity of water in the interlayer exerts a detrimental effect on its properties. There exists a need in the art to produce an interlayer having the desired fire resistant properties in a more cost effective manner.

### SUMMARY OF THE INVENTION

We have now discovered that it is possible to spread a waterglass solution onto the surface of a flexible backing material and to dry the solution in situ to form a bilayer material comprising a clear flexible pseudo plastic film and the flexible backing material. The clear film may be separated from the flexible backing material and incorporated into a laminated glazing having fire resistant properties. Thus from one aspect this invention provides a process for the production of a clear flexible film comprising an alkali metal silicate waterglass which process comprises spreading a waterglass solution upon the surface of a flexible backing material, drying said solution to form a clear flexible film and separating said film from said backing material.

### DETAILED DESCRIPTION OF THE PREFERRED EMBODIMENTS

The waterglass solutions useful in the processes of the present invention are those which can be dried to form a clear pseudo plastic flexible film. A preferred group are the sodium silicate waterglasses wherein the weight ratio SiO₂:Na₂O is less than 3.3:1 and more preferably less than 3.0:1. Other alkali metal waterglasses especially potassium silicate waterglasses and lithium silicate waterglasses are also useful in the compositions of this invention. Mixtures of a sodium silicate waterglass with either or both of a potassium silicate waterglass and/or a lithium silicate are also useful in the processes of the present invention. The preferred sodium silicate waterglasses are those wherein the weight ratio SiO₂:Na₂O is at least 2.0:1, more preferably at least 2.5:1 and most preferably those wherein this ratio has a value which is in the range 2.5:1 to 3.0:1. Sodium silicate waterglasses having a weight ratio SiO₂:Na₂O of 2.0:1, 2.5:1, 2.85:1 and 3.3:1 are available as articles of commerce. Waterglass having a weight ratio SiO₂:Na₂O other than these specific values may be produced by blending the appropriate quantities of the commercially available solutions.

Where the waterglass solution comprises a mixture of sodium with potassium and/or lithium silicate waterglasses we prefer than the molar ratio of sodium ions to that of potassium and/or lithium ions is at least 2:1. Where a potassium silicate waterglass is used the molar ratio of sodium to potassium is preferably at least 4:1. Where a potassium silicate waterglass is present it will preferably have a weight ratio SiO₂:K₂O in the range 1.43:1 to 2.05:1.

The solutions useful in the processes of this invention preferably further comprise a polyhydric organic compound. The presence of such a compound improves the flexibility of the dried interlayer. Examples of useful polyhydric compound include glycerol, ethylene glycol and monosaccharides and polysaccharides such as sorbitol. The preferred polyhydric compound for use in the processes of the present invention is glycerol.

The waterglass solution will preferably comprise at least 6% more preferably at least 8% and most preferably at least 10% by weight of the polyhydric compound prior to drying. The incorporation of excessive quantities of polyhydric compound can have a deleterious effect upon the properties of the dried interlayer and for this reason we prefer that the solution comprises no more than 20% by weight of an organic polyhydric compound. The preferred solutions comprise from 6 to 10% and more preferably from 7 to 9% by weight of glycerol.

The amount of water in the solution prior to drying may vary through a wide range provided the solution is clear and stable. In general the solutions will comprise from 30 to 70%, by weight of water.

The solution is spread upon the surface of a flexible backing material. The backing material may be supported on a flat rigid surface and maintained under tension so as to avoid any wrinkling or sagging when the solution is spread on top of it.

A wide variety of materials are potentially useful as backing materials. In order to be useful the backing materials must be resistant to the action of the waterglass solution which is strongly alkaline and generally has a pH in the range 10 to 13. The surface of the backing material should be one which can be wetted by the waterglass solution and separated from the dried film. The backing material will have a smooth surface onto which the waterglass solution can be spread. It will preferably be at least as flexible as the dried film. Preferred backing materials include polymeric films such as formed from polyolefins especially polypropylene, polyesters and polytetrafluoroethylene (PTFE) and copolymers thereof.

The amount of waterglass solution which is poured onto the backing material will be sufficient to provide the desired thickness of flexible film after the drying step. In general we prefer to use an amount such that the depth of the wet solution on the backing material prior to the drying step is from 0.5 to 2.5 mm and preferably from 1.0 to 1.5 mm. In order to retain that quantity of solution upon the surface of the backing material it may be necessary to provide an edge barrier defining the area to be coated which is mounted in a liquid tight fashion on the surface of the backing material and is sufficiently high to retain the desired depth of solution.

The ability of the waterglass solution to wet out on the surface of the backing materials is a significant factor in selecting a backing material. If the ability of the solution to wet the surface is too low the solution may form islands on the surface of the backing material and the dried film may not take the form of a continuous sheet or will take the form of a film having non-uniform thickness. If the solution wets the surface of the backing material too well it may be difficult to form a flexible film having the desired thickness and it may be difficult to separate the film from the backing material without damaging the integrity of the film. In general we prefer to use backing materials which have a surface energy of less than 50 dynes/cm.

We have discovered that the incorporation of a surfactant into the waterglass solution may improve the ability of the solution to wet a surface. The introduction of a surfactant into the waterglass solution alters its surface energy and thereby its tendency to spread on the surface of a substrate. Waterglass solutions comprising a surfactant which can be dried to form a clear fire resistant interlayer are believed to be novel and such solutions provide a further aspect of this invention. The surfactants which are useful in this embodiment of the invention must be chemically stable in the solution and in the dried film, will preferably be miscible with the solution and will not detract significantly from the transparency of the dried flexible film. In general non-ionic surfactants and in particular polyhydroxy non-ionic surfactants are preferred for present use. A particularly preferred class of surfactants are the alkyl glucosides. The utility of any particular surfactant in any particular solution may be determined by routine experiment.

The quantity of surfactant used will generally be that which is sufficient to achieve the desired degree of wetting on the backing material. This amount may be determined empirically. The use of excessive quantities of surfactant tends to give rise to the formation of hazy dried films and is thereby less preferred. In general the quantity of surfactant used will be from 0.0001 to 0.1% by weight of the waterglass solution.

The waterglass solutions may comprise additional materials which are known to be useful as components of the dried interlayer. For example they may comprise a compatible zirconium containing aggregate of the type described in our International application WO 01/10638 and in particular potassium zirconium carbonate and complexes of zirconium with citric acid and gylcerol of the type described in British Patent 2226024. Another useful class of additives are the salts of carbonic acid or a hydroxy carboxylic acids such as citric acid including those described in our International Patent application WO 01/24445. Another useful class of additives are those which may be formed by the addition of an alkali metal aluminate and an a hydroxy carboxylic acid such as citric acid as described in our pending UK patent application 0218672.4. The aluminate and citrate must be mixed with the waterglass under controlled conditions with thorough mixing to produce a solution which is clear and can be dried to form a clear interlayer according to the present invention.

In order to produce a clear transparent elastomeric film which is free from bubbles and other optical imperfections it is necessary to dry the waterglass solution under carefully controlled conditions. The water content of the solution is reduced in the drying step and the water content of the dried film is generally in the range 10 to 35%. The temperature of the solution, composition of the atmosphere above it and the Relative Humidity in that atmosphere will be controlled with care during the drying step. These parameters may vary over the course of the drying process so as to optimise the properties and the homogeneity of the dried film. In a preferred embodiment the solution may be heated from both above and below so as to avoid the entrapment of excessive quantities of water in the elastomeric material. In the preferred embodiments the process may be carried out by laying the flexible backing material on a heat conductive support such as a metal plate.

The drying process may be carried out statically or dynamically. In a preferred embodiment the process is carried out dynamically in a continuous manner by spreading a waterglass solution onto the surface of a belt of flexible backing material which is being fed to the process from a feed roll. The belt then passes through a heating zone where it is dried and a film of clear pseudo plastic material is produced on the coated surface. The conditions within the heating zone and optionally within different parts of the heated zone and the speed at which the belt passes through the beating zone are controlled so as to produce a useful film.

The heating zone may be heated using radiant heat or convected heat. The temperature within the heating zone will generally be in the range 80° C. to 150° C. The heating zone may be divided into two or more zones each of which is maintained at its own temperature and humidity. The drying time may vary through a wide range but will generally be from 20 to 200 minutes. The product comprises a bilayer material comprising the backing material and the flexible film. Such bilayers are believed to be novel and comprise a further aspect of this invention.

The bilayers may be separated into their two components and the clear dried flexible film used as a component of laminated glazings having fire resistant properties. This separation may take place immediately after the drying step is completed or the bilayer may be stored and/or transported to another location before being separated into its components.

### EXAMPLE 1

An aqueous waterglass solution was made up by mixing the following components.

70.9 parts by weight of a sodium silicate Solution having a weight ratio SᵢO₂:Na₂O of 2.85:1 comprising 33.9% solids produced by diluting a sodium silicate solution sold by Clariant France S.A as Clariant PL 1548 having a weight ratio of SiO₂ : Na₂O of 3.3:1 with pure sodium hydroxide.

20 parts by weight of a potassium silicate solution having a weight ratio SiO₂:K₂O of 1.43:1 comprising 52.4% by weight solids, sold by the Crosfield Company as Crystal K120 Potassium Silicate.

9 parts by weight of glycerol.

0.1 parts by weight of an alkyl glucoside surfactant

The compounds were mixed and formed a clear solution. That solution was poured onto a polypropylene film supported upon a steel belt in a quantity sufficient to provide a depth of 1.5 mm. The wet film was passed through a heating zone wherein the temperature was in the range 80 to 140° C. and the Relative Humidity varied from 5 to 70%. The film was moved through the zone over a period of 60 minutes. The water content of the dried flexible film product was approximately 22% by weight. The film had a thickness of 0.5 mm.

### EXAMPLE 2

A solution comprising a sodium aluminate, a sodium silicate waterglass, a potassium silicate waterglass and citric acid was made up using the following components:
1 A solution of a sodium silicate waterglass having a weight ration SiO₂:Na₂O of 2.85:1 and comprising 40% by weight of solids, sold by INEOS as Crystal 96.

2 A solution of a potassium silicate waterglass having a weight ration of SiO₂:K₂O of 1.43:1 comprising 52.4% by weight of solids; sold by INEOS as Crystal K120 potassium silicate

3 An aqueous solution of sodium aluminate comprising 38.0% by weight solids sold by Nordisk Aluminate

4 Glycerol—an 87% by weight solution in water

5 Citric acid—reagent grade

The solutions were made up as follows:

First 5 parts by weight of citric acid were added to 10 parts by weight of glycerol with stirring so that the citric acid dissolved. The resulting solution is added slowly with vigorous stirring to 89.86 parts by weight of the sodium aluminate solution. The temperature of the solution was maintained below 50° C. throughout the addition. The resulting solution had a pH of 9.5.

A waterglass solution comprising a sodium silicate , a potassium silicate and glycerol was made up by mixing 151.7 parts by weight of Crystal 96 with 44.3 parts by weight of Crystal K120 and 20.5 parts by weight of glycerol.

A waterglass solution comprising a sodium silicate , a potassium silicate and glycerol was made up by mixing 151.7 parts by weight of Crystal 96 with 44.3 parts by weight of Crystal K120 and 20.5 parts by weight of glycerol.

The mixed solution comprising the aluminate was then added to the waterglass solution. The addition was carried out by slowly adding the aluminate solution with thorough mixing using a Silverson high shear mixer. The resulting solution was clear and was stable on storage at room temperature.

The solution was poured onto a roll of polypropylene film which mounted upon two rollers positioned upon either side of an oven. The film was drawn through the heating zone. The solution was poured onto the film at a point adjacent to the entrance to the oven. The polypropylene film was drawn across the surface of a stainless steel table mounted within the oven. The oven was heated using convected air and was maintained at a temperature of 100° C. The residence time in the oven was 120 minutes.

The product which was drawn from the oven was a clear bilayer film. The dried interlayer had a water content of 25%. The dried interlayer could be peeled from the polypropylene . The interlayer was placed upon a sheet of float glass having a thickness of 3 mm the surface of which had been wetted with glycerol. The surface of the interlayer was wetted with gylcerol. A second sheet of glass was placed on top of the interlayer. The excess interlayer was trimmed from the edge of the glass and the glazing was laminated by passing it through a pair of nip rollers.

1. A process for the production of a clear, transparent flexible film comprising an alkali metal silicate waterglass which comprises:
spreading a waterglass solution upon the surface of a flexible backing material;
drying said solution to form a clear film; and
separating said film from said backing material; wherein
said solution comprises at least 6% by weight of a polyhydric compound.

2. A process according to claim 1, wherein the backing material is a polymeric film.

3. A process according to claim 2, wherein the backing material is a polyolefin film.

4. A process according to claim 3, wherein the polyolefin is polypropylene.

5. A process according to claim 1, wherein the flexible backing material is supported on a flat rigid surface.

6. A process according to claim 1, wherein the edge barrier defining the area onto which the waterglass solution is spread is mounted on the surface of the backing material in a liquid tight fashion.

7. A process according to claim 1, wherein the waterglass solution is spread upon the surface of a continuous belt of the flexible backing material.

8. A process according to claim 7, wherein the belt carrying the waterglass solution is passed through a heating zone where the waterglass solution is dried to form a clear flexible film.

9. A process according to claim 8, wherein the clear film is separated from the flexible backing material.

10. A process according to claim 8, wherein a bilayer material comprising the flexible backing material and the clear film is produced and collected for storage.

11. A process for the production of a clear, transparent flexible film which is free of optical imperfections, comprising an alkali metal silicate waterglass which comprises:
spreading a waterglass solution upon the surface of a flexible backing material;
drying said solution to form a clear film; and
separating said film from said backing material; wherein
said solution comprises at least 6% by weight of a polyhydric compound.

12. A process for the production of a clear, transparent flexible film on a laminated glazing, the film comprising an alkali metal silicate waterglass, wherein the process comprises:
spreading a waterglass solution upon the surface of a flexible backing material;
drying said solution to form a clear film; and
separating said film from said backing material; wherein
said solution comprises at least 6% by weight of a polyhydric compound.
